(19) United States
(12) Patent Application Publication
(10) Pub. No.: US 2025/0081977 A1
(43) Pub. Date: Mar. 13, 2025

(54) METHOD FOR MANUFACTURING STEAMED SWEET POTATO

(71) Applicant: Hadong Yullim Farming Association Corporation, Hadong-gun (KR)

(72) Inventor: Kyeong Tae CHOI, Jinju-si (KR)

(73) Assignee: Hadong Yullim Farming Association Corporation, Hadong-gun (KR)

(21) Appl. No.: 18/764,410

(22) Filed: Jul. 5, 2024

(30) Foreign Application Priority Data
Sep. 7, 2023 (KR) 10-2023-0118989

(51) Int. Cl. A23L 3/40; A23L 5/10; A23L 19/10

(52) U.S. Cl. CPC A23B 2/90; A23L 5/13; A23L 19/105

(57) ABSTRACT

A method for manufacturing steamed sweet potatoes, includes: a first step of preparing a sweet potato, a second step of peeling the washed sweet potato, a third step of forming the peeled sweet potato into a cube shape, a fourth step of drying the formed sweet potato at a temperature of 15 to 25° C., and a fifth step of putting the dried sweet potato in a retort and heating it, wherein, one of the sweet potato varieties Sodammi, Beniharuka, or Hofungmi is selected for this method.

### CROSS-REFERENCE TO PRIOR APPLICATION

This application claims priority to Korean Patent Application No. 10-2023-0118989 (filed on Sep. 7, 2023), which is hereby incorporated by reference in its entirety.

### BACKGROUND

The present invention relates to a method for manufacturing steamed sweet potatoes processed by retort for easy storage and consumption at room temperature.

Sweet potatoes are widely cultivated throughout Korea. They grow to about 3 meters in length, with stems that extend along the ground and take root. The leaves are arranged alternately, with the leaf blades shallowly split into a heart shape. When cut, the leaves and stems exude sap. Roots grow from the base of the petioles at the bottom of the stem, and some of these roots grow underground to become tuberous roots, commonly known as sweet potatoes. The shape of sweet potatoes varies, including cylindrical shapes with pointed ends and ball shapes. Their color also varies, ranging from white, yellow, light red, red, to light purple. Globally, sweet potatoes are available in various varieties based on their appearance, taste, growth speed, flesh color (white, yellow, red, and purple), and viscosity. For industrial use, varieties with high starch content and high yield are preferred, while for feed, varieties that allow for the harvesting of both sweet potatoes and vines are favored.

In particular, the honey sweet potato varieties commonly preferred by the public include the Japanese variety Beniharuka and the newly developed Korean variety Sodammi. Beniharuka, developed in Japan, has a sugar content of 26 to 27 Brix when steamed. It features a slender, smooth shape and a distinct purple color. The newly developed Sodammi variety boasts a sugar content of over 29 Brix when steamed. Named ‘Sodammi’ for its luscious and appetizing appearance, it has a purple color with red skin and deep yellow flesh. Additionally, Sodammi exhibits almost no rot or internal hollowing even when stored at room temperature for over 9 months. Therefore, it can be stored for extended periods, allowing for controlled shipping times. These characteristics make Sodammi preferred by producers and distributors.

In the past, however, there were problems with the quality and shelf life of steamed sweet potatoes.

### PRIOR ART DOCUMENTS

### Patent Documents

(Patent Document 1) Korean Patent Publication No. 10-2023-0042848

### SUMMARY

Accordingly, the purpose of the present invention is to provide a method for manufacturing steamed sweet potatoes that overcomes the problems of the prior art as described above and solves quality and shelf life problems.

According to the features of the present invention for achieving the above-mentioned purpose, the present invention provides a method for manufacturing steamed sweet potatoes, which comprises a first step of preparing a sweet potato, a second step of peeling the prepared sweet potato, a third step of forming the peeled sweet potato into a cube shape, a fourth step of drying the formed sweet potato at a temperature of 15 to 25° C., and a fifth step of putting the dried sweet potato in a retort and processing it, wherein, one of the sweet potato varieties Sodammi, Beniharuka, or Hofungmi is selected for this method.

In the above second step, the prepared sweet potato is peeled to a thickness of 2 to 4 mm.

In the above fourth step, the formed sweet potato is dried at a temperature of 15 to 25° C. to a moisture content of 5 to 15%.

In the above fifth step, the dried sweet potato is placed in a retort, and is first heated at a temperature of 90 to 100° C. for 10 to 20 minutes, and then is secondarily heated at a temperature of 110 to 130° C. for 15 to 25 minutes.

In the fifth step, the processed sweet potato is further cooled for 10 to 20 minutes.

A method for manufacturing steamed sweet potatoes according to the present invention has the following beneficial effects.

Dried sweet potatoes made with conventional sweet potato mousse have a hard texture. However, the steamed sweet potatoes of the present invention are soft and sweet, making them enjoyable for people of all ages, including as snacks for infants.

### BRIEF DESCRIPTION OF THE DRAWING

The FIGURE is a flow chart showing a method for manufacturing steamed sweet potatoes according to the present invention.

### DESCRIPTION OF SIGNS

S1 Step of preparing a sweet potato
S2: Step of peeling the prepared sweet potato
S3: Step of forming the peeled sweet potatoes into cubes
S4: Step of drying the cube-shaped sweet potato
S5: Step of putting the dried sweet potato into a retort and heat it
F1 1st heating step
F2: 2^{nd} heating step
C1: Cooling step

### DETAILED DESCRIPTION

Hereinafter, a preferred embodiment of a method for manufacturing steamed sweet potatoes according to the present invention will be described in detail with reference to the attached figures.

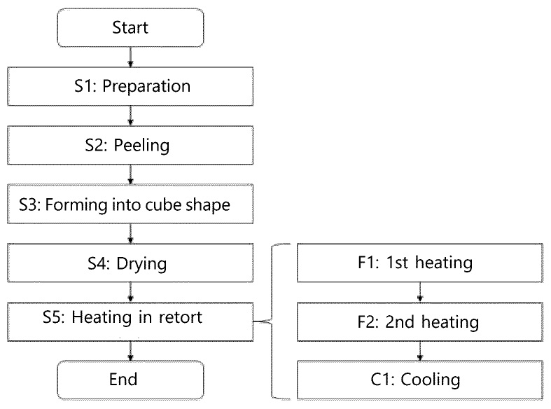

A method for manufacturing steamed sweet potatoes according to the present invention comprises, as shown in FIG. 1, a step (S1) of preparing a sweet potato, a second step (S2) of peeling the prepared sweet potato, a third step (S3) of forming the peeled sweet potato into a cube shape, a fourth step (S4) of drying the formed sweet potato at a temperature of 15 to 25° C., and a fifth step (S5) of placing the dried sweet potatoes in a retort and processing it.

Step 1 (S1) involves preparing the sweet potato. First, the sweet potato is placed in a washing container, brushed to remove dirt or dust, and then washed with water. Next, both ends of the sweet potato are cut by 3 cm. Specifically, both ends of the sweet potato are connected to the stem and contain fiber components. If both ends are cut to less than 3 cm, the remaining fiber reduces the texture and interferes with moisture absorption during the steaming process, causing the sweet potato to not steam well. In addition, the sweet potato is selected from among the Sodammi, Beniharuka, or Hopungmi varieties. More specifically, it is preferable to select the Sodammi variety.

Step 2 (S2) involves peeling the prepared sweet potato. The sweet potato skin is peeled to a thickness of 2 to 4 mm. If the skin is peeled to less than 2 mm, the color of the steamed sweet potato turns brown or black, and the texture and overall flavor are reduced. Conversely, if the skin is peeled to more than 4 mm, the color of the steamed sweet potato is maintained, but the texture becomes dry, reducing overall flavor.

Step 3 (S3) involves shaping the peeled sweet potato into a cube. Specifically, the peeled sweet potato is inserted into a machine designed to shape it into a cube.

Step 4 (S4) involves drying the formed sweet potato at a temperature of 15 to 25° C. to a moisture content of 5 to 15%. If the sweet potato is dried at a temperature below 15° C., the resulting steamed sweet potato will have a sticky texture, negatively impacting its quality. Conversely, if dried at a temperature above 25° C., the steamed sweet potato will have a dry texture, thereby reducing its commercial value. Furthermore, if the sweet potato is dried to a moisture content below 5%, the final product will exhibit a sticky texture. On the other hand, if the moisture content exceeds 15%, the steamed sweet potato will have a dry texture, again diminishing its commercial value.

Step 5 (S5) involves placing the dried sweet potato in a retort, performing a first heating (F1) at a temperature of 90 to 100° C. for 10 to 20 minutes, and then a second heating (F2) at a temperature of 115 to 125° C. for 15 to 25 minutes. The reason for heating the dried sweet potato twice is to maintain the color and texture of the sweet potato during heating. If the first heating (F1) is conducted at a temperature below 90° C., the resulting steamed sweet potato maintains its color and texture, but the sterilization rate decreases, reducing its commercial value. If the temperature exceeds 100° C., the sterilization rate remains at 100%, but the steamed sweet potato turns brown or black and its texture becomes dry, diminishing its commercial value. Additionally, if the heating time for the first heating (F1) is less than 10 minutes, the steamed sweet potato retains its color and texture, but the sterilization rate falls below 100%, reducing its value as a product. If the heating time exceeds 20 minutes, the sterilization rate remains at 100%, but the steamed sweet potato turns brown or black and its texture becomes dry, thereby diminishing its commercial value.

If heated at a temperature below 115° C. during the second heating (F2), the manufactured steamed sweet potato maintains its color and texture, but its sterilization rate drops and the product loses its value. If heated at a temperature above 125° C., the manufactured steamed sweet potato maintains its sterilization rate at 100%, but turns brown or black and its texture becomes dry, losing its value as a product. Additionally, if the heating time is less than 15 minutes during the second heating (F2), the manufactured steamed sweet potato maintains its color and texture, but its sterilization rate drops below 100%, losing its value as a product. If the heating time exceeds 25 minutes, the manufactured steamed sweet potato maintains its sterilization rate at 100%, but turns brown or black and its texture becomes dry, losing its value as a product.

The above Step 5 (S5) further includes a cooling (C1) process of the processed sweet potato for 10 to 20 minutes. If the sealed sweet potato is cooled for less than 10 minutes, the heat of the heated sweet potato is not sufficiently reduced, which may cause quality problems later. If the cooling is performed for more than 20 minutes, the heat of the sweet potato is sufficiently reduced to maintain quality, but it is not economically effective.

Hereinafter, the experimental results for a method for manufacturing steamed sweet potatoes according to the present invention will be described in detail.

### 1. Sensory Evaluation According to Sweet Potato Peeling Thickness

To compare the quality characteristics of steamed sweet potatoes, graduate students from the Department of Food Engineering, recognized as suitable inspectors, were appropriately trained for the purpose of this experiment before participating in the sensory evaluation. The sensory evaluation assessed both texture and overall flavor using a 9-point Likert scale method, where 9 points indicated “very good” and 1 point indicated “very bad.”

### Comparative Example 1

Comparative example 1: A sweet potato is prepared, washed, and peeled to a thickness of 1 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is then secondarily heated at 120° C. for 20 minutes. Finally, the heated sweet potato is cooled for 15 minutes to complete the process.

### Embodiment 1

Embodiment 1: A sweet potato is prepared, washed, and peeled to a thickness of 2 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 2

Embodiment 2: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 3

Embodiment 3: A sweet potato is prepared, washed, and peeled to a thickness of 4 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 4

Embodiment 4: A sweet potato is prepared, washed, and peeled to a thickness of 5 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

TABLE 1

| | Peeling | | Sweetness | | Overall |
|---|---|---|---|---|---|
| | thickness (mm) | Color | (Brix) | Texture | flavor |
| Comparative | 1 | Black | 22.8 | 7 | 7 |
| example 1 | | | | | |
| Embodiment 1 | 2 | Brown | 25.6 | 8.7 | 8 |
| Embodiment 2 | 3 | Yellow | 29 | 9 | 9 |
| Embodiment 3 | 4 | Yellow | 29 | 8.1 | 7.2 |
| Embodiment 4 | 5 | Yellow | 29 | 7 | 6.8 |

As shown in Table 1 above, when the peeling thickness of the sweet potato was less than 2 mm, the manufactured steamed sweet potato turned brown or black, resulting in poor texture and overall flavor. Conversely, when the peeling thickness exceeded 4 mm, the manufactured steamed sweet potato maintained its color, but the texture became dry, reducing overall flavor.

### 2. Sensory Evaluation According to Sweet Potato Drying Temperature

To compare the quality characteristics of steamed sweet potatoes, graduate students from the Department of Food Engineering, recognized as suitable inspectors, were appropriately trained for the purpose of this experiment before participating in the sensory evaluation. The sensory evaluation assessed both texture and overall flavor using a 9-point Likert scale method, where 9 points indicated “very good” and 1 point indicated “very bad.”

### Comparative Example 2

Comparative example 2: A sweet potato is prepared, washed, and peeled to a thickness of 3 mm, then formed into a cube shape. The cube-shaped sweet potato is dried at a temperature of 10° C. for 4 hours. The dried sweet potato is placed in a retort and first heated at 95° C. for 15 minutes. The first-heated sweet potato is then secondarily heated at 120° C. for 20 minutes. Finally, the heated sweet potato is cooled for 15 minutes to complete the process.

### Embodiment 5

Embodiment 5: A sweet potato is prepared, washed, and peeled to a thickness of 3 mm, then formed into a cube shape. The cube-shaped sweet potato is dried at a temperature of 15° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 6

Embodiment 6: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 7

Embodiment 7: A sweet potato is prepared, washed, and peeled to a thickness of 3 mm, then formed into a cube shape. The cube-shaped sweet potato is dried at a temperature of 25° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 8

Embodiment 8: A sweet potato is prepared, washed, and peeled to a thickness of 3 mm, then formed into a cube shape. The cube-shaped sweet potato is dried at a temperature of 30° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

TABLE 2

| | Drying | Moisture | | | | |
|---|---|---|---|---|---|---|
| | temp | removal | | Sweetness | Tex- | Overall |
| | (° C.) | rate (%) | Color | (Brix) | ture | flavor |
| Comparative | 10 | 7 | Yellow | 24.5 | 7 | 6.9 |
| example 2 | | | | | | |
| Embodiment | 15 | 8.8 | Yellow | 26.8 | 7.8 | 7.6 |
| 5 | | | | | | |
| Embodiment | 20 | 10 | Yellow | 29 | 9 | 9 |
| 6 | | | | | | |
| Embodiment | 25 | 11 | Brown | 29 | 8.2 | 8.1 |
| 7 | | | | | | |
| Embodiment | 30 | 12.4 | Black | 29 | 7.2 | 7.3 |
| 8 | | | | | | |

As shown in Table 2 above, when the drying temperature was below 15° C., the manufactured steamed sweet potato remained yellow, but its texture became sticky, resulting in poor texture and overall flavor. When the drying temperature exceeded 25° C., the manufactured steamed sweet potato turned brown or black, and its texture became dry, reducing overall flavor.

### 3. Sensory Evaluation According to Sweet Potato Drying Time

To compare the quality characteristics of steamed sweet potatoes, graduate students from the Department of Food Engineering, recognized as suitable inspectors, were appropriately trained for the purpose of this experiment before participating in the sensory evaluation. The sensory evaluation assessed both texture and overall flavor using a 9-point Likert scale method, where 9 points indicated “very good” and 1 point indicated “very bad.”

### Comparative Example 3

Comparative example 3: A sweet potato is prepared, washed, and peeled to a thickness of 3 mm, then formed into a cube shape. The cube-shaped sweet potato is dried at a temperature of 20° C. for 2 hours. The dried sweet potato is placed in a retort and first heated at 95° C. for 15 minutes. The first-heated sweet potato is then secondarily heated at 120° C. for 20 minutes. Finally, the heated sweet potato is cooled for 15 minutes to complete the process.

### Embodiment 9

Embodiment 9: A sweet potato is prepared, washed, and peeled to a thickness of 3 mm, then formed into a cube shape. The cube-shaped sweet potato is dried at a temperature of 20° C. for 3 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 10

Embodiment 10: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 11

Embodiment 11: A sweet potato is prepared, washed, and peeled to a thickness of 3 mm, then formed into a cube shape. The cube-shaped sweet potato is dried at a temperature of 20° C. for 5 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 12

Embodiment 12: A sweet potato is prepared, washed, and peeled to a thickness of 3 mm, then formed into a cube shape. The cube-shaped sweet potato is dried at a temperature of 20° C. for 6 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

TABLE 3

| | Drying | Moisture | | | | |
|---|---|---|---|---|---|---|
| | time | removal | | Sweetness | Tex- | Overall |
| | (H) | rate (%) | Color | (Brix) | ture | flavor |
| Comparative | 2 | 6.5 | Yellow | 26 | 7.3 | 7.3 |
| example 3 | | | | | | |
| Embodiment | 3 | 8 | Yellow | 28.4 | 8.8 | 8.5 |
| 9 | | | | | | |
| Embodiment | 4 | 10 | Yellow | 29 | 9 | 9 |
| 10 | | | | | | |
| Embodiment | 5 | 11.6 | Brown | 29 | 8.7 | 8.6 |
| 11 | | | | | | |
| Embodiment | 6 | 12.5 | Black | 29 | 7 | 7 |
| 12 | | | | | | |

As shown in Table 3 above, when the drying time was less than 3 hours, the manufactured steamed sweet potato remained yellow, but the texture became sticky, reducing both the texture and overall flavor. Conversely, when the drying time exceeded 5 hours, the manufactured steamed sweet potato turned brown or black, and the texture became dry, also reducing both the texture and overall flavor.

### 4. Sterilization Rate Experiment and Sensory Evaluation According to the First Heating Temperature in the Retort Processing Stage

To compare the quality characteristics of steamed sweet potatoes, graduate students from the Department of Food Engineering, recognized as suitable inspectors, were appropriately trained for the purpose of this experiment before participating in the sensory evaluation. The sensory evaluation assessed both texture and overall flavor using a 9-point Likert scale method, where 9 points indicated “very good” and 1 point indicated “very bad.”

### Comparative Example 4

Comparative example 4: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 85° C. for 15 minutes. The first-heated sweet potato is then secondarily heated at 120° C. for 20 minutes. Finally, the heated sweet potato is cooled for 15 minutes to complete the process.

### Embodiment 13

Embodiment 13: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 90° C. for 15 minutes. The first-heated sweet potato is secondarily heated at 120° C. for 20 minutes. The heated sweet potato is cooled for 15 minutes to complete the process.

### Embodiment 14

Embodiment 14: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 15

Embodiment 15: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 100° C. for 15 minutes. The first-heated sweet potato is secondarily heated at 120° C. for 20 minutes. The heated sweet potato is cooled for 15 minutes to complete the process.

### Embodiment 16

Embodiment 16: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 105° C. for 15 minutes. The first-heated sweet potato is secondarily heated at 120° C. for 20 minutes. The heated sweet potato is cooled for 15 minutes to complete the process.

TABLE 4

| | Heating | Steril- | | | | |
|---|---|---|---|---|---|---|
| | temp | ization | | Sweetness | | Overall |
| | (° C.) | rate(%) | Color | (BRix) | Texture | flavor |
| Comparative | 85 | 99.1 | Yellow | 27.7 | 8.5 | 8.2 |
| example 4 | | | | | | |
| Embodiment | 90 | 99.6 | Yellow | 28.2 | 8.7 | 8.6 |
| 13 | | | | | | |
| Embodiment | 95 | 100 | Yellow | 29 | 9 | 9 |
| 14 | | | | | | |
| Embodiment | 100 | 100 | Brown | 29 | 8.8 | 8.9 |
| 15 | | | | | | |
| Embodiment | 105 | 100 | Black | 29 | 8.2 | 7.9 |
| 16 | | | | | | |

As shown in Table 4 above, when the heating temperature was below 90° C., the manufactured steamed sweet potato maintained its color, texture, and overall flavor, but its sterilization rate fell below 100%, thereby losing its value as a product. Conversely, when the heating temperature exceeded 100° C., the manufactured steamed sweet potato turned brown or black, and its texture became dry, thereby reducing its overall flavor, although its sterilization rate was maintained at 100%.

### 5. Sterilization Rate Experiment and Sensory Evaluation According to the First Heating Time in the Retort Processing Stage

To compare the quality characteristics of steamed sweet potatoes, graduate students from the Department of Food Engineering, recognized as suitable inspectors, were appropriately trained for the purpose of this experiment before participating in the sensory evaluation. The sensory evaluation assessed both texture and overall flavor using a 9-point Likert scale method, where 9 points indicated “very good” and 1 point indicated “very bad.”

### Comparative Example 5

Comparative example 5: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 5 minutes. The first-heated sweet potato is then secondarily heated at 120° C. for 20 minutes. Finally, the heated sweet potato is cooled for 15 minutes to complete the process.

### Embodiment 17

Embodiment 17: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 10 minutes. The first-heated sweet potato is secondarily heated at 120° C. for 20 minutes. The heated sweet potato is cooled for 15 minutes to complete the process.

### Embodiment 18

Embodiment 18: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 19

Embodiment 19: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 20 minutes. The first-heated sweet potato is secondarily heated at 120° C. for 20 minutes. The heated sweet potato is cooled for 15 minutes to complete the process.

### Embodiment 20

Embodiment 20: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 20 minutes. The first-heated sweet potato is secondarily heated at 120° C. for 25 minutes. The heated sweet potato is cooled for 15 minutes to complete the process.

TABLE 5

| | Heating | Steril- | | | | |
|---|---|---|---|---|---|---|
| | temp | ization | | Sweetness | | Overall |
| | (min) | rate (%) | Color | (Brix) | Texture | flavor |
| Comparative | 5 | 98.8 | Yellow | 28.6 | 8.6 | 8.5 |
| example 5 | | | | | | |
| Embodiment | 10 | 99 | Yellow | 28.8 | 8.7 | 8.7 |
| 17 | | | | | | |
| Embodiment | 15 | 100 | Yellow | 29 | 9 | 9 |
| 18 | | | | | | |
| Embodiment | 20 | 100 | Brown | 29 | 8.8 | 8.8 |
| 19 | | | | | | |
| Embodiment | 25 | 100 | Black | 29 | 8.4 | 8.3 |
| 20 | | | | | | |

As shown in Table 5 above, when the heating time was less than 10 minutes, the manufactured steamed sweet potato maintained its color, texture, and overall flavor, but the sterilization rate fell below 100%, thereby losing its value as a product. Conversely, when the heating time exceeded 20 minutes, the manufactured steamed sweet potato turned brown or black, the texture became dry, and the overall flavor declined, although the sterilization rate was maintained at 100%.

### 6. Sterilization Rate Experiment and Sensory Evaluation According to the Second Heating Temperature in the Retort Processing Stage

To compare the quality characteristics of steamed sweet potatoes, graduate students from the Department of Food Engineering, recognized as suitable inspectors, were appropriately trained for the purpose of this experiment before participating in the sensory evaluation. The sensory evaluation assessed both texture and overall flavor using a 9-point Likert scale method, where 9 points indicated “very good” and 1 point indicated “very bad.”

### Comparative Example 6

Comparative example 6: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is then secondarily heated at 110° C. for 20 minutes. Finally, the heated sweet potato is cooled for 15 minutes to complete the process.

### Embodiment 21

Embodiment 21: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 115° C. for 20 minutes. The heated sweet potato is cooled for 15 minutes to complete the process.

### Embodiment 22

Embodiment 22: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 23

Embodiment 23: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 125° C. for 20 minutes. The heated sweet potato is cooled for 15 minutes to complete the process.

### Embodiment 24

Embodiment 24: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 130° C. for 20 minutes. The heated sweet potato is cooled for 15 minutes to complete the process.

TABLE 6

| | Heating | Steril- | | | | |
|---|---|---|---|---|---|---|
| | temp | ization | | Sweetness | | Overall |
| | (° C.) | rate (%) | Color | (Brix) | Texture | flavor |
| Comparative | 110 | 98.9 | Yellow | 26.8 | 8.3 | 8.3 |
| example 6 | | | | | | |
| Embodiment | 115 | 99.2 | Yellow | 27 | 8.4 | 8.3 |
| 21 | | | | | | |
| Embodiment | 120 | 100 | Yellow | 29 | 9 | 9 |
| 22 | | | | | | |
| Embodiment | 125 | 100 | Brown | 29 | 8.5 | 8.5 |
| 23 | | | | | | |
| Embodiment | 130 | 100 | Black | 29 | 8.1 | 8 |
| 24 | | | | | | |

As shown in Table 6 above, when the heating temperature was below 115° C., the manufactured steamed sweet potato maintained its color, texture, and overall flavor, but the sterilization rate fell below 100%, thereby losing its value as a product. Conversely, when the heating temperature exceeded 125° C., the manufactured steamed sweet potato turned brown or black, and the texture became dry, thereby reducing the overall flavor, although the sterilization rate was maintained at 100%.

### 7. Sterilization Rate Experiment and Sensory Evaluation According to the Second Heating Time in the Retort Processing Stage

To compare the quality characteristics of steamed sweet potatoes, graduate students from the Department of Food Engineering, recognized as suitable inspectors, were appropriately trained for the purpose of this experiment before participating in the sensory evaluation. The sensory evaluation assessed both texture and overall flavor using a 9-point Likert scale method, where 9 points indicated “very good” and 1 point indicated “very bad.”

### Comparative Example 7

Comparative example 7: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is then secondarily heated at 120° C. for 10 minutes. Finally, the heated sweet potato is cooled for 15 minutes to complete the process.

### Embodiment 25

Embodiment 25: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 15 minutes. The heated sweet potato is cooled for 15 minutes to complete the process.

### Embodiment 26

Embodiment 26: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 20 minutes. The heated sweet potato is cooled for 15 minutes to complete the process.

### Embodiment 27

Embodiment 27: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 25 minutes. The heated sweet potato is cooled for 15 minutes to complete the process.

### Embodiment 28

Embodiment 28: A sweet potato is prepared, washed, and peeled to a thickness of 3 mm, then formed into a cube shape. The cube-shaped sweet potato is dried at a temperature of 20° C. for 4 hours. The dried sweet potato is placed in a retort and first heated at 95° C. for 15 minutes. The first-heated sweet potato is secondarily heated at 120° C. for 30 minutes. The heated sweet potato is cooled for 15 minutes to complete the process.

TABLE 7

| | Heating | Steril- | | | | |
|---|---|---|---|---|---|---|
| | time | ization | | Sweetness | | Overall |
| | (min) | rate (%) | Color | (Brix) | Texture | flavor |
| Comparative | 10 | 98.7 | Yellow | 26.7 | 8.3 | 8.2 |
| example 7 | | | | | | |
| Embodiment | 15 | 99.6 | Yellow | 27.3 | 8.6 | 8.6 |
| 25 | | | | | | |
| Embodiment | 20 | 100 | Yellow | 29 | 9 | 9 |
| 26 | | | | | | |
| Embodiment | 25 | 100 | Brown | 29 | 8.5 | 8.4 |
| 27 | | | | | | |
| Embodiment | 30 | 100 | Black | 29 | 8.3 | 8 |
| 28 | | | | | | |

As shown in Table 7 above, when the heating time was less than 15 minutes, the manufactured steamed sweet potato maintained its color, texture, and overall flavor, but the sterilization rate fell below 100%, thereby losing its value as a product. Conversely, when the heating time exceeded 25 minutes, the manufactured steamed sweet potato turned brown or black, and the texture became dry, thereby reducing the overall flavor, although the sterilization rate was maintained at 100%.

In this way, it will be understood by those skilled in the art that the technical configuration of the present invention described above can be implemented in other specific forms without changing the technical idea or essential features of the present invention.

Therefore, it should be understood that the embodiments described above are illustrative and not restrictive in any respect. The scope of the present invention is defined by the claims set forth below, rather than by the detailed description provided above. Any changes or modifications that fall within the meaning and scope of the claims and their equivalents should be considered as being included within the scope of the present invention.

1. A method for manufacturing steamed sweet potatoes comprising: a first step of preparing sweet potato;
a second step of peeling the prepared sweet potato;
a third step of forming the peeled sweet potato into a cube shape;
a fourth step of drying the formed sweet potato at a temperature of 15 to 25° C.; and
a fifth step of putting the dried sweet potato into a retort and processing them,
wherein, one of the sweet potato varieties Sodammi, Beniharuka, or Hofungmi is selected for this method.

2. The method for manufacturing steamed sweet potatoes according to claim 1, comprising Step 2 in which the sweet potatoes are peeled to a thickness of 2 to 4 mm.

3. The method for manufacturing steamed sweet potatoes according to claim 1,
comprising Step 4 in which the above formed sweet potatoes are dried at a temperature of 15 to 25° C. to a moisture content of 5 to 15%.

4. The method for manufacturing steamed sweet potatoes according to claim 1,
comprising Step 5 in which the above dried sweet potatoes are placed in a retort, first heated at a temperature of 90 to 100° C. for 10 to 20 minutes, and second heated at a temperature of 115 to 125° C. for 15 to 25 minutes.

5. The method for manufacturing steamed sweet potatoes in the claim 1,
comprising Step 5 which further includes cooling the processed sweet potatoes for 10 to 20 minutes.
